(19) United States
(12) Patent Application Publication
(10) Pub. No.: US 2020/0272990 A1
(43) Pub. Date: Aug. 27, 2020

(54) PHYSICAL DISTRIBUTION MANAGEMENT SYSTEM, INFORMATION PROCESSING DEVICE, MOBILE OBJECT, AND PHYSICAL DISTRIBUTION MANAGEMENT METHOD

(71) Applicant: TOYOTA JIDOSHA KABUSHIKI KAISHA, Toyota-shi (JP)

(72) Inventors: Hiromichi Dogishi, Nagoya-shi (JP); Masaki Shitara, Nagakute-shi (JP); Keiji Yamashita, Nisshin-shi (JP); Nozomi Kaneko, Nagoya-shi (JP); Naoki Yamamuro, Nagoya-shi (JP); Shunsuke Tanimori, Susono-shi (JP); Ryoichi Shiraishi, Anjo-shi (JP)

(73) Assignee: TOYOTA JIDOSHA KABUSHIKI KAISHA, Toyota-shi (JP)

(21) Appl. No.: 15/929,214

(22) Filed: Jan. 31, 2020

(30) Foreign Application Priority Data
Feb. 26, 2019 (JP) 2019-033207

(51) Int. Cl. G06Q 10/08; G06Q 30/02

(52) U.S. Cl. CPC G06Q 10/08345; G06Q 30/0207

(57) ABSTRACT

Provided is a physical distribution management system including an autonomously traveling vehicle that delivers a commodity and a server that cooperates with the autonomously traveling vehicle via a network. The autonomously traveling vehicle includes a mobile-object storage unit configured to store first management information including a volume of stock of the commodity and a mobile-object control unit. The server includes a management storage unit configured to store second management information including demand prediction information of the commodity. The mobile-object control unit is configured to perform setting a price for provision when the commodity is provided based on the first management information and the second management information acquired from the server and correcting the price for provision based on at least one of a degree of demand for the commodity in customers and the volume of stock of the commodity.

### INCORPORATION BY REFERENCE

The disclosure of Japanese Patent Application No. 2019-033207 filed on Feb. 26, 2019 including the specification, drawings and abstract is incorporated herein by reference in its entirety.

### BACKGROUND

### 1. Technical Field

The disclosure relates to a physical distribution management system, an information processing device, a mobile object, and a physical distribution management method.

### 2. Description of Related Art

Japanese Patent Application Publication No. 2018-124676 (JP 2018-124676 A) discloses a management device that can ascertain whether luggage is to be delivered using an automated-driving vehicle when a client designates a luggage delivering method using an automated-driving vehicle. This management device includes a communication control unit serving as a receiver unit that receives delivery destination information on a delivery destination of luggage which is transmitted from a client terminal and receives designation of a luggage delivering method using an automated-driving vehicle which is transmitted from the client terminal and a delivery destination area determining unit that determines a delivery destination area corresponding to the delivery destination information based on the received delivery destination information. The management device further includes a parking/stopping prohibition determining unit that determines whether parking/stopping of a vehicle in the delivery destination area is prohibited based on the determined delivery destination area, a notification information generating unit that generates first notification information indicating whether delivery to the delivery destination indicated by the delivery destination information using an automated-driving vehicle is possible based on the result of determination from the parking/stopping prohibition determining unit, and a communication control unit serving as a transmitter unit that transmits the generated first notification information to the client terminal.

### SUMMARY

In general, sales of a commodity vary depending on a demand therefor. Since this variation in sales depending on a demand affects a flow of the commodity, stock control, and the like, it is desirable to reflect the variation in sales in physical distribution management, a system therefor, or the like. However, in the management device disclosed in JP 2018-124676 A, such variation in sales depending on a demand is not considered and thus there is room for improvement. The disclosure is for effectively providing a commodity in consideration of a degree of demand for a commodity in customers at the time of provision of the commodity.

According to an aspect of the disclosure, there is provided a physical distribution management system including: a mobile object that delivers a commodity; and an information processing device that cooperates with the mobile object via a network. For example, the mobile object includes a mobile-object storage unit configured to store first management information including a volume of stock of the commodity and a mobile-object control unit. The information processing device includes a management storage unit configured to store second management information including demand prediction information of the commodity. The mobile-object control unit is configured to perform: setting a price for provision when the commodity is provided based on the first management information and the second management information acquired from the information processing device; and correcting the price for provision based on at least one of a degree of demand for the commodity in customers and the volume of stock of the commodity. In another example, the mobile object includes a mobile-object storage unit configured to store first management information including a volume of stock of the commodity, the information processing device includes a management storage unit configured to store second management information including demand prediction information of the commodity and a management control unit. The management control unit is configured to perform: setting a price for provision when the commodity is provided based on the first management information acquired from the mobile object and the second management information; correcting the price for provision based on at least one of a degree of demand for the commodity in customers and the volume of stock of the commodity; and notifying the mobile object of the customer to which the commodity is provided at the corrected price for provision.

According to another aspect of the disclosure, there is provided an information processing device that cooperates with a mobile object that delivers a commodity via a network. For example, the information processing device includes a management control unit configured to perform: setting a price for provision when the commodity is provided based on first management information including a volume of stock of the commodity acquired from the mobile object and second management information including demand prediction information of the commodity; correcting the price for provision based on at least one of a degree of demand for the commodity in customers and the volume of stock of the commodity; and notifying the mobile object of the customer to which the commodity is provided at the corrected price for provision.

According to still another aspect of the disclosure, there is provided a mobile object in a system in which a plurality of mobile objects that delivers a commodity cooperates with each other. For example, the mobile object includes: a first storage unit configured to store first management information including a volume of stock of the commodity; a second storage unit configured to store second management information including demand prediction information of the commodity; and a mobile-object control unit. The mobile-object control unit is configured to perform: setting a price for provision when the commodity is provided based on the first management information and the second management information; and correcting the price for provision based on at least one of a degree of demand for the commodity in customers and the volume of stock of the commodity.

According to still another aspect of the disclosure, there is provided a physical distribution management method which is cooperatively performed by a mobile object that delivers a commodity and an information processing device that cooperates with the mobile object via a network. The physical distribution management method includes: setting a price for provision when the commodity is provided based on first management information including a volume of stock of the commodity acquired from the mobile object and second management information including demand prediction information of the commodity; and adjusting the set price for provision and an order of providing the commodity based on at least one of a degree of demand for the commodity in customers and the volume of stock of the commodity.

According to the disclosure, it is possible to effectively provide a commodity in consideration of a degree of demand for a commodity in customers at the time of provision of the commodity.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a conceptual diagram illustrating a physical distribution management system according to a first embodiment of the disclosure;

FIG. 2 is a block diagram schematically illustrating a configuration in the physical distribution management system illustrated in FIG. 1 and particularly illustrating a configuration of an autonomously traveling vehicle;

FIG. 3 is a block diagram schematically illustrating a configuration in the physical distribution management system illustrated in FIG. 1 and particularly illustrating a configuration of a server;

FIG. 4 is a block diagram schematically illustrating a configuration in the physical distribution management system illustrated in FIG. 1 and particularly illustrating a configuration of a user terminal;

FIG. 5 is a flowchart illustrating a routine of setting a price for provision of a commodity in the physical distribution management system illustrated in FIG. 1;

FIG. 6 is a diagram illustrating a display example on a display unit of a user terminal in the physical distribution management system illustrated in FIG. 1;

FIG. 7 is a flowchart illustrating a routine of correcting a price for provision of a commodity in the physical distribution management system illustrated in FIG. 1;

FIG. 8 is a flowchart illustrating a routine of ordering a commodity in the physical distribution management system illustrated in FIG. 1;

FIG. 9 is a diagram illustrating a display example of an input screen for ordering conditions on a display unit of a user terminal in the physical distribution management system illustrated in FIG. 1;

FIG. 10 is a block diagram schematically illustrating a configuration in a physical distribution management system according to a second embodiment of the disclosure and particularly illustrating a configuration of an autonomously traveling vehicle;

FIG. 11 is a block diagram schematically illustrating a configuration in the physical distribution management system according to the second embodiment and particularly illustrating a configuration of a server;

FIG. 12 is a flowchart illustrating a routine of ordering a commodity in the physical distribution management system according to the second embodiment; and

FIG. 13 is a block diagram schematically illustrating a configuration in a physical distribution management system according to a third embodiment of the disclosure and particularly illustrating a configuration of an autonomously traveling vehicle.

### DETAILED DESCRIPTION OF EMBODIMENTS

Hereinafter, embodiments of the disclosure will be described with reference to the accompanying drawings. First, a first embodiment of the disclosure will be described below.

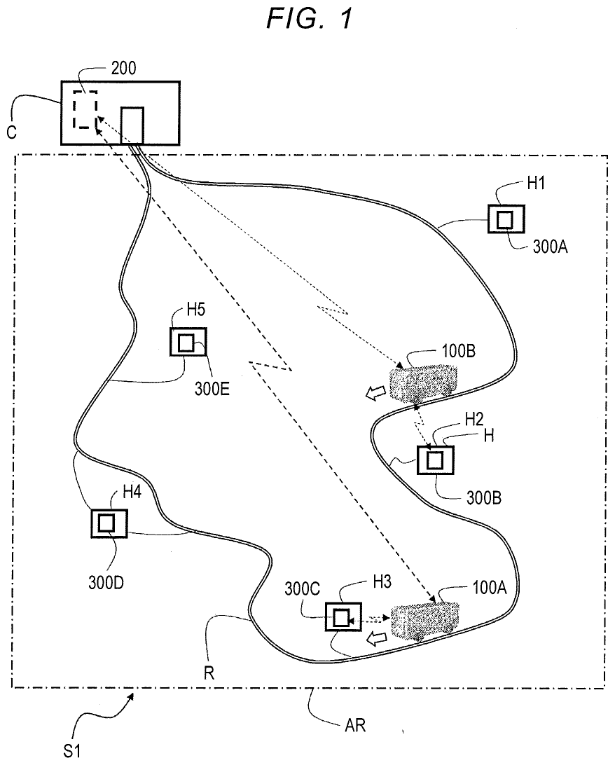

FIG. 1 conceptually illustrates a physical distribution management system S1 according to the first embodiment of the disclosure. The physical distribution management system S1 includes autonomously traveling vehicles 100 and a server 200. Each autonomously traveling vehicle 100 is an example of a mobile object that delivers a commodity. The server 200 is an information processing device and is a computer over a network N. The server 200 is configured to communicate with the autonomously traveling vehicles 100 via the network N and cooperates with the autonomously traveling vehicles 100 via the network N. In FIG. 1, two autonomously traveling vehicles 100A and 100B are illustrated out of a plurality of autonomously traveling vehicles 100, but the number of autonomously traveling vehicles 100 is not limited thereto.

In FIG. 1, a route R extending to a physical distribution center C extends in a predetermined area AR. Autonomously traveling vehicles 100 (100A and 100B) travel along the route R. The autonomously traveling vehicles 100 can have commodities loaded therein, basically travel along the route R, and deliver the commodities to stores or homes (hereinafter simply referred to as “stores) H (H1, H2, H3, H4, and H5). The server 200 is provided on the physical distribution center C side. The server 200 may not be provided in the physical distribution center C, but is provided in the physical distribution center C in this example. The server 200 can communicate with another server or the like via the network N. User terminals 300 (300A, 300B, 300C, 300D, and 300E) are correlated with the stores H (H1, H2, H3, H4, and H5). The user terminals 300 are configured to communicate with the autonomously traveling vehicles 100 via the network N and can receive information from the autonomously traveling vehicles 100 and transmit information in response to the received information. In FIG. 1, five stores H are illustrated, but the number of stores H is not limited thereto. That is, the number of user terminals 300 is not limited to five and may be set to any number.

Each autonomously traveling vehicle 100 is also referred to as an electric vehicle (EV) pallet. Each autonomously traveling vehicle 100 is a mobile object that can be subjected to automated driving and unmanned driving, and there are various autonomously traveling vehicles with various sizes depending on applications thereof. For example, autonomously traveling vehicles 100 with various sizes including an autonomously traveling vehicle with a small size which is suitable for transporting several books and an autonomously traveling vehicle with a large size which can transport persons and objects can be used. Each autonomously traveling vehicle 100 is a vehicle that delivers commodities. Particularly, in this embodiment, each autonomously traveling vehicle 100 is a vehicle that can also be used as a mobile shop. Examples of the mobile shop include retail stores such as a foodstuff store, a clothing store, a shoe store, and a flower shop. The stores H may be mobile shops each employing an autonomously traveling vehicle 100.

Each autonomously traveling vehicle 100 has a control function and a communication function for controlling the autonomously traveling vehicle 100, providing a user interface to a user who uses the autonomously traveling vehicle 100, and transmitting and receiving information to and from various servers over a network. Each autonomously traveling vehicle 100 provides a user with functions and services which are provided by a server over a network in addition to processes which can be performed by the autonomously traveling vehicle 100 alone in cooperation with the server over the network. Each autonomously traveling vehicle 100 is not necessarily an unmanned vehicle. For example, occupants such as sales staff, service staff, or security personnel may be in the autonomously traveling vehicle 100. The autonomously traveling vehicle 100 may not be a vehicle that can travel completely autonomously. For example, the autonomously traveling vehicle 100 may be a vehicle which is driven by a person or of which driving is assisted by a person depending on the situation. In this embodiment, the autonomously traveling vehicle 100 may travel based on a predetermined operation command, deliver commodities, and serve as a mobile shop.

Each autonomously traveling vehicle 100 may have functions of receiving a request from a user, responding to the user, performing a predetermined process in response to the request from the user, and reporting a result of process to the user. A request from a user who cannot be processed by the autonomously traveling vehicle 100 alone may be transmitted to the server 200 and be processed in cooperation with the server 200.

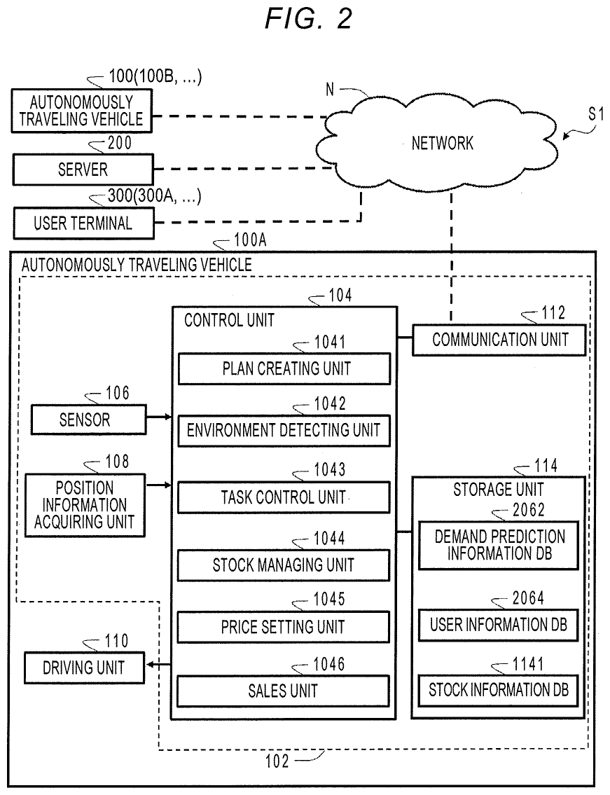

As described above, the autonomously traveling vehicles 100 are configured to communicate with the user terminals 300 (300A, . . . ) illustrated in FIGS. 2 to 4 via the network N. The user terminals 300 can receive an input and an operation corresponding thereto from a user and transmit the input information to the autonomously traveling vehicles 100 via the network N. The user terminals 300 may communicate directly with the autonomously traveling vehicles 100.

The server 200 is also a device that instructs the autonomously traveling vehicles 100 to operate. For example, the server 200 travels on a predetermined route R and transmits an operation command for selling loaded commodities to the autonomously traveling vehicles 100.

Elements in the physical distribution management system S1 illustrated in FIG. 1 will be described below in detail. FIG. 2 is a block diagram schematically illustrating a configuration in the physical distribution management system S1 including the autonomously traveling vehicles 100, the server 200, and the user terminals 300 illustrated in FIG. 1 and particularly illustrating a configuration of an autonomously traveling vehicle 100. In FIG. 2, the configuration of an autonomously traveling vehicle 100A is illustrated as an example of the autonomously traveling vehicle 100. The other autonomously traveling vehicle 100B or the like has the same configuration as the autonomously traveling vehicle 100A.

The autonomously traveling vehicle 100A illustrated in FIG. 2 includes an information processing device 102 and further includes a control unit 104 that substantially takes charge of the functions thereof. The autonomously traveling vehicle 100A can travel in accordance with an operation command acquired from the server 200. Specifically, the autonomously traveling vehicle 100A generates a travel route based on the operation command acquired via the network N and travels on the travel route while sensing the surroundings of the vehicle.

The autonomously traveling vehicle 100A further includes a sensor 106, a position information acquiring unit 108, a driving unit 110, a communication unit 112, and a storage unit 114. The autonomously traveling vehicle 100A operates with electric power which is supplied from a battery.

The sensor 106 is a unit that senses the surrounding of the host vehicle and typically includes a stereo camera, a laser scanner, a Light Detection and Ranging or Laser Imaging Detection and Ranging (LIDAR), and a radar. Information which is acquired by the sensor 106 is transmitted to the control unit 104. The sensor 106 includes sensors for allowing the host vehicle to travel autonomously. The sensor 106 may include a camera which is provided on a vehicle body of the autonomously traveling vehicle 100A. For example, the sensor 106 may include an imaging device using an image sensor such as a charged-coupled device (CCD) or a metal-oxide semiconductor (MOS) or complementary metal-oxide-semiconductor (CMOS). A plurality of cameras may be provided at a plurality of positions on the vehicle body. For example, cameras may be provided on the front, rear, right, and left sides of the vehicle body.

The position information acquiring unit 108 is a unit that acquires a current position of the host vehicle and typically includes a Global Positioning System (GPS) receiver. Information which is acquired by the position information acquiring unit 108 is transmitted to the control unit 104. The GPS receiver which is a satellite signal receiver receives signals from a plurality of GPS satellites. The GPS satellites are artificial satellites that go around the earth. A satellite positioning system, that is, a navigation satellite system (NSS), is not limited to a GPS. Position information may be detected based on signals from various satellite positioning systems. The NSS is not limited to a global navigation satellite system and may include a quasi-zenith satellite system (QZSS) such as “Galileo” in Europe or “Michibiki” in Japan which is operated integrally with the GPS.

The control unit 104 is a computer that controls the autonomously traveling vehicle 100A based on information acquired from the sensor 106, the position information acquiring unit 108, or the like. The control unit 104 is an example of a control unit that receives an operation command from the server 200 and controls traveling of the autonomously traveling vehicle 100A which is a mobile object.

The control unit 104 includes a CPU and a main storage unit and performs information processing in accordance with a program. The CPU is also referred to as a processor. The main storage unit of the control unit 104 is an example of a main storage device. The CPU of the control unit 104 executes a computer program which is executably loaded into the main storage unit and provides various functions. The main storage unit of the control unit 104 stores programs which are executed by the CPU, data, and the like. The main storage unit of the control unit 104 includes a dynamic random access memory (DRAM), a static random access memory (SRAM), and a read only memory (ROM).

The control unit 104 is connected to the storage unit 114. The storage unit 114 is a so-called external storage unit, is used as a memory area for assisting the main storage unit of the control unit 104, and stores programs which are executed by the CPU of the control unit 104, data, and the like. The storage unit 114 includes a hard disk drive or a solid state drive (SSD).

The control unit 104 includes a plan creating unit 1041, an environment detecting unit 1042, a task control unit 1043, a stock managing unit 1044, a price setting unit 1045, and a sales unit 1046 as functional modules. The functional modules are embodied by causing the control unit 104, that is, the CPU thereof, to execute a program stored in the main storage unit or the storage unit 114. The control unit 104 corresponds to a mobile-object control unit and the main storage unit or the storage unit 114 corresponds to a mobile-object storage unit.

The plan creating unit 1041 acquires an operation command, for example, from the server 200 and creates an operation plan of the host vehicle. In this embodiment, an operation plan is data in which a route on which the autonomously traveling vehicle 100A travels and processes to be performed by the autonomously traveling vehicle 100A in a part or all of the route are defined. Examples of data included in an operation plan are as follows.

(1) Data in which a route on which the host vehicle travels is expressed by a set of road links

For example, a route on which the host vehicle travels may be automatically generated based on a departure position and a destination which are given with reference to map data which is stored in the storage unit 114. In the example illustrated in FIG. 1, data in which the host vehicle travels basically on the route R can be generated. The route may be generated using an external service.

(2) Data in which processes to be performed by the host vehicle at points on the route are defined

Examples of the processes to be performed by the host vehicle on the route include “delivering a predetermined commodity,” “serving as a mobile shop,” “receiving predetermined luggage,” “handing predetermined luggage over,” and “receiving a receipt or a deposit receipt,” but are not limited thereto. The operation plan which is created by the plan creating unit 1041 is transmitted to the task control unit 1043 which will be described later.

The environment detecting unit 1042 detects an environment around the host vehicle based on data which is acquired by the sensor 106. Examples of a detection target include the number or positions of lanes, the number or positions of vehicles which are located near the host vehicle, the number or positions of obstacles (for example, a pedestrian, a bicycle, a structure, or a building) which are located near the host vehicle, structures of roads, and road signs, but are not limited thereto. The detection target is not particularly limited as long as it is required for autonomous traveling. The environment detecting unit 1042 may track a detected object. For example, a relative speed of an object may be calculated based on a difference between the coordinates of the object which are previously detected and the current coordinates of the object. Data on the environment (hereinafter referred to as “environmental data”) which is detected by the environment detecting unit 1042 is transmitted to the task control unit 1043 which will be described later.

The task control unit 1043 controls traveling of the host vehicle based on the operation plan created by the plan creating unit 1041, the environmental data generated by the environment detecting unit 1042, and the position information of the host vehicle acquired by the position information acquiring unit 108. For example, the host vehicle is controlled such that the host vehicle travels on a predetermined route and an obstacle does not enter a predetermined safety area centered on the host vehicle. Any known method can be employed as the method of causing a vehicle to travel autonomously. The task control unit 1043 performs a task other than traveling based on the operation plan created by the plan creating unit 1041. Examples of the task include trading of loaded luggage with a user, handover of a commodity to a user, and issuance of a receipt or a deposit receipt.

The stock managing unit 1044 manages statuses of commodities, that is, stock, varying with loading of commodities into the autonomously traveling vehicle 100A, trading of commodities, and the like. Specifically, the stock managing unit 1044 stores stock statuses of commodities which are stored in an updateable stock information database 1141 of the storage unit 114. The stock information database 1141, that is, information therein, corresponds to first management information herein and the storage unit 114 particularly corresponds to a mobile-object storage unit. The main storage unit of the control unit 104 may be a mobile-object storage unit and the stock information database 1141 may be stored therein. The stock information database 1141, that is, information therein, includes information of commodities such as an amount of commodities remaining, that is, a volume of stock.

The stock managing unit 1044 acquires information on stock of the same commodity or receipt of the same commodity as the commodity loaded into the host vehicle from the server 200 which is an information processing device or another autonomously traveling vehicle 100 (for example, the autonomously traveling vehicle 100B) and updates the stock information database 1141. In this embodiment, update of the stock information database 1141 is performed by acquiring information periodically every predetermined period via the network N. However, update of the stock information database 1141 may be performed, for example, irregularly. The stock information database 1141 includes information on whether there is a likelihood that the commodity will be additionally provided to the user from another mobile object and stock information or receipt information of the commodity in the physical distribution management system S1 as information on the commodity loaded into the host vehicle.

The price setting unit 1045 sets a price for provision of the commodity when the commodity is provided, that is, when the commodity is sold. The price setting unit 1045 sets the price for provision when the commodity is provided based on information in the stock information database 1141 and information in a demand prediction information database 2062. Specifically, the price setting unit 1045 sets the price for provision when the commodity is provided in an area AR of the route R. The demand prediction information database 2062 is provided from the server 200 and is stored in the storage unit 114 herein.

The sales unit 1046 provides sales information of the commodity including the price of the commodity set by the price setting unit 1045 to a customer, that is, a user and provides the commodity to the user who is a customer while correcting the price for provision of the commodity based on a degree of demand for the commodity included in ordering conditions of the commodity from the user. Provision of sales information to a user, ordering of the commodity from a user, and the like are performed via a user terminal 300. Provision of sales information to a user is performed by displaying sales information on a website, and is actively performed on a specific user terminal 300 additionally based on information in a user information database 2064 stored in the storage unit 114. The autonomously traveling vehicle 100 can specify a user terminal 300 which has a nearby address or an address in a nearby region, or the like as position information by searching the user information database 2064 based on the current position acquired by the position information acquiring unit 108. FIG. 1 conceptually illustrates a scene in which an autonomously traveling vehicle 100A communicates with a user terminal 300C which is approached by the autonomously traveling vehicle 100A and an autonomously traveling vehicle 100B communicates with a user terminal 300B which is approached by the autonomously traveling vehicle 100B. The user information database 2064 is managed by the server 200 herein, provided to the autonomously traveling vehicle 100A, and stored in the storage unit 114, but may be provided from another device via the network N. The user information database 2064 includes at least position information such as an address and contact information (a communication destination) which are correlated with user terminals 300. When ordering of the commodity has been settled through communication with a user terminal 300, the sales unit 1046 generates an operation command for selling the commodity to a user who is a determined customer and sends the generated operation command to the plan creating unit 1041. Correcting of a price for provision of the commodity in this process is performed in accordance with a first rule and a second rule which will be described below. The first rule is to set the price for provision to be higher for a user with a shorter delivery time of the commodity. Regarding how high a price for provision is to be set, for example, a relationship between a delivery time and an extra price may be defined in a table. The relationship between a delivery time and an extra price may be defined by a function. The second rule is to set the price for provision to be higher for a user with a higher priority level of provision. Regarding how high a price for provision is to be set, for example, a relationship between a priority level which can be designated at the time of ordering the commodity and an extra price may be defined in a table. The sales unit 1046 can additionally give a predetermined incentive at the time of providing the commodity. An example of the incentive is points associated with a discount for the commodity or the like. For example, when the commodity is preferentially provided to a new customer instead of an existing customer, the price for provision of the commodity can be corrected to be higher than the price for provision when the commodity is provided to the existing customer, and a predetermined incentive can be given to the commodity which is provided to the existing customer.

The driving unit 110 is a unit that causes the autonomously traveling vehicle 100A to travel based on a command generated by the task control unit 1043. The driving unit 110 includes, for example, a motor, an inverter, a brake, a steering mechanism, and a secondary battery that are used to drive vehicle wheels.

The communication unit 112 includes a communication module that connects the autonomously traveling vehicle 100A to the network N. In this embodiment, the autonomously traveling vehicle 100A can communicate with another device such as the server 200 or a user terminal 300 via the network N. The communication unit 112 may further include a communication module that is used for the autonomously traveling vehicle 100A which is the host vehicle to perform vehicle-to-vehicle communication with other autonomously traveling vehicles 100 (100B, . . . ).

The autonomously traveling vehicle 100A may include a unit into which luggage is loaded or a commodity display shelf. The autonomously traveling vehicle 100A can include other elements. The autonomously traveling vehicle 100A may include a mechanism that hands over or receives only predetermined luggage out of various types of luggage. For example, a housing device including a plurality of storage areas (also referred to as blocks) may be provided in a passenger compartment and only a permitted block may be able to be unlocked. The autonomously traveling vehicle 100A may include a mechanism that hands over and receives loaded luggage to and from other devices. For example, the autonomously traveling vehicle 100A may include a mechanism that accesses an external housing device which is called a home delivery locker and transfers luggage thereto. The autonomously traveling vehicle 100A may include a device that issues a receipt or a deposit receipt. These mechanisms or devices are controlled by the task control unit 1043.

The server 200 will be described below. The server 200 is a device that acquires result information on sales of commodities as information indicating a degree of demand for commodities from a plurality of autonomously traveling vehicles 100 and constructs and updates a sales result database 2061. The server 200 is a device that acquires and analyzes information in the sales result database 2061 and constructs and updates the demand prediction information database 2062. The demand prediction information database 2062 includes demand prediction information of commodities. The server 200 is a device that acquires information on a plurality of autonomously traveling vehicles 100, for example, information in the stock information database 1141, from the plurality of autonomously traveling vehicles 100 and constructs and updates a vehicle information database 2063 in which information on the autonomously traveling vehicles 100 is defined. The server 200 is a device that provides the demand prediction information database 2062 or the user information database 2064 to the autonomously traveling vehicles 100. The server 200 is a device that generates an operation command such as a commodity sales command based on the vehicle information database 2063, that is, the information therein and transmits the generated operation command to the autonomously traveling vehicles 100.

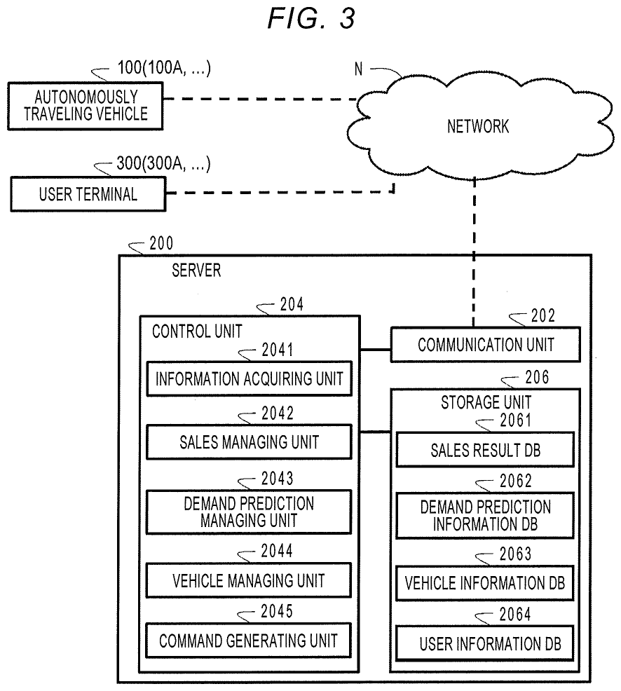

The server 200 is an information processing device and includes a communication unit 202, a control unit 204, and a storage unit 206 as illustrated in FIG. 3. The communication unit 202 has the same configuration as the communication unit 112 and has a communication function of connecting the server 200 to the network N. The communication unit 202 of the server 200 is a communication interface that communicates with autonomously traveling vehicles 100 and user terminals 300 via the network N. The control unit 204 includes a CPU and a main storage unit similarly to the control unit 104, and performs information processing in accordance with a program. The CPU is also a processor and the main storage unit of the control unit 204 is an example of a main storage device. The CPU of the control unit 204 executes a computer program which is executably loaded into the main storage unit and provides various functions. The main storage unit of the control unit 204 stores a computer program which is executed by the CPU, data, and the like. The main storage unit of the control unit 204 includes a DRAM, an SRAM, or a ROM.

The control unit 204 is connected to the storage unit 206. The storage unit 206 is an external storage unit, is used as a memory area for assisting the main storage unit of the control unit 204, and stores a computer program which is executed by the CPU of the control unit 204, data, and the like. The storage unit 206 includes a hard disk drive or an SSD.

The control unit 204 is a unit that takes care of control of the server 200. As illustrated in FIG. 3, the control unit 204 includes an information acquiring unit 2041, a sales managing unit 2042, a demand prediction managing unit 2043, a vehicle managing unit 2044, and a command generating unit 2045 as function modules. These functional modules are embodied by causing the CPU of the control unit 204 to execute a program stored in the main storage unit or the storage unit 206. The control unit 204 corresponds to a management control unit, and the main storage unit or the storage unit 206 corresponds to a management storage unit.

The information acquiring unit 2041 acquires a variety of information, for example, data, from autonomously traveling vehicles 100 or user terminals 300 particularly periodically herein. The information acquiring unit 2041 acquires result information on sales of commodities from a plurality of autonomously traveling vehicles 100. The information acquiring unit 2041 transmits the acquired information to the sales managing unit 2042, the demand prediction managing unit 2043, the vehicle managing unit 2044, or the like. The information acquiring unit 2041 periodically acquires position information from the autonomously traveling vehicles 100, information in the stock information database 1141, and the like and transmits the acquired information to the vehicle managing unit 2044.

The sales managing unit 2042 arranges information on sales of commodities of the autonomously traveling vehicles 100 acquired via the information acquiring unit 2041 in accordance with a program, and constructs and updatably manages the sales result database 2061. The sales result database 2061 is stored in the storage unit 206. For example, the sales result database 2061 is constructed by collecting commodities and the numbers of commodities which are sold in correlation with conditions such as a sales region, a date and time, a day, a temperature, humidity, an amount of rainfall, and an amount of snowfall and is configured to be searched by items or the like. The sales result database 2061 has only to be collection of sales results in a predetermined period, for example, in one year or several years.

The demand prediction managing unit 2043 acquires information in the sales result database 2061, analyzes the acquired information in accordance with a program, and constructs and manages the demand prediction information database 2062 including demand prediction information of commodities. The demand prediction information database 2062 is updatably stored in the storage unit 206. For example, with the demand prediction information database 2062, prediction of commodities and the numbers of commodities which are sold with respect to a date and time, a day, a time period, weather conditions, and the like is arranged for each customer, specifically, for each region, and a degree of demand for a commodity for each customer can be retrieved.

The vehicle managing unit 2044 manages information of a plurality of autonomously traveling vehicles 100 under management. Specifically, the vehicle managing unit 2044 receives information such as data on a plurality of autonomously traveling vehicles 100 from the plurality of autonomously traveling vehicles 100 via the information acquiring unit 2041 at intervals of a predetermined period, and stores the received information in the storage unit 206. Position information and vehicle information are used as the information on the autonomously traveling vehicles 100. Examples of the vehicle information include an identifier, a usage or type, information on a waiting point (a garage or a business office), a door type, a vehicle body size, a cargo compartment size, a loading capacity, a travelable distance in a fully charged state, a travelable distance at a current time point, and a current status of each autonomously traveling vehicle 100, but are not limited thereto. The current status includes information in the stock information database 1141 such as a type of a store, an amount of commodities loaded thereon, that is, volumes of stock of commodities, and types of the commodities.

The command generating unit 2045 generates an operation command such as a commodity sales command based on the vehicle information database 2063, that is, information therein, and transmits the generated operation command to an autonomously traveling vehicle 100. Information in the demand prediction information database 2062 can also be considered to generate the operation command.

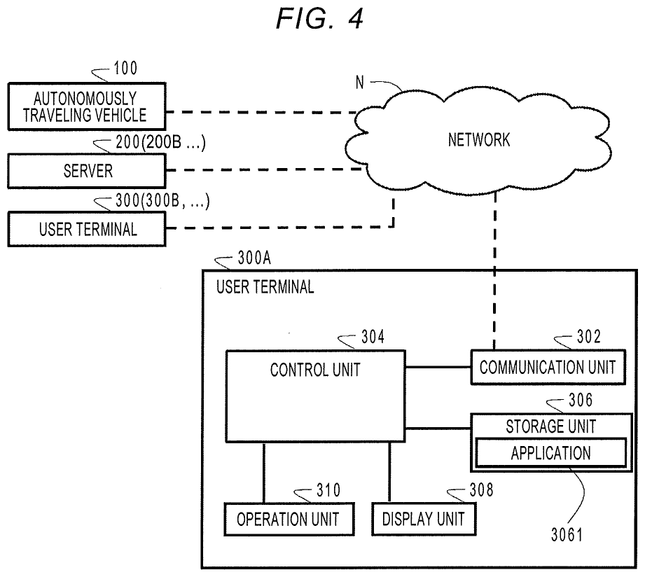

A user terminal 300 will be described below. A user terminal 300 is, for example, a mobile terminal, a smartphone, or a personal computer. For example, a user terminal 300A illustrated in FIG. 4 includes a communication unit 302, a control unit 304, and a storage unit 306. The communication unit 302 and the storage unit 306 of the user terminal 300A have the same configurations as the communication unit 202 and the storage unit 206 of the server 200. The user terminal 300A includes a display unit 308 and an operation unit 310. The display unit 308 is, for example, a liquid crystal display or an electroluminescence panel. The operation unit 310 is, for example, a keyboard or a pointing device. More specifically, in this embodiment, the operation unit 310 includes a touch panel and is substantially incorporated into the display unit 308.

Similar to the control unit 204 of the server 200, the control unit 304 includes a CPU and a main storage unit. The CPU of the control unit 304 executes an application program (hereinafter referred to as an application) 3061 which is stored in the storage unit 306. The application 3061 is, for example, a web browser or an application program for accessing commodity sales information transmitted from an autonomously traveling vehicle 100A. The application 3061 includes a GUI, receives an input from user, for example, an access, and transmits the received input to the autonomously traveling vehicle 100A via the network N.

In FIGS. 2 to 4, the autonomously traveling vehicles 100, the server 200, and the user terminals 300 are connected to each other via the same network N. This connection may be realized using a plurality of networks. For example, a network for connecting the autonomously traveling vehicles 100 and the server 200 and a network for connecting the autonomously traveling vehicles 100 and the user terminals 300 may be different from each other.

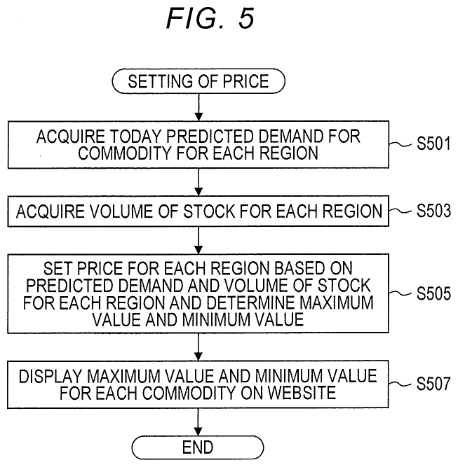

Processes in the physical distribution management system S1 having the above-mentioned configuration will be described below with reference to the flowchart illustrated in FIG. 5. The flowchart illustrated in FIG. 5 represents a flow of a routine of setting a price for provision of a commodity which is performed by an autonomously traveling vehicle 100. In the first embodiment, the control unit 104 of an autonomously traveling vehicle 100 performs the routine illustrated in FIG. 5, but the routine in the first embodiment is not limited thereto. For example, the server 200 may perform the routine illustrated in FIG. 5 to transmit execution results to the autonomously traveling vehicles 100.

An autonomously traveling vehicle 100, that is, the price setting unit 1045 of the control unit 104, sets a price for provision when a commodity is provided in a certain region based on the stock information database 1141 and the demand prediction information database 2062. First, the price setting unit 1045 acquires a today predicted demand for a commodity which is loaded for each region (Step S501). This is acquired by searching the demand prediction information database 2062 based on a day and weather conditions of today, a region, and the like. The predicted demand may be acquired based on the result of search of the demand prediction information database 2062 and a predetermined arithmetic operation.

On the other hand, the price setting unit 1045 of the control unit 104 of an autonomously traveling vehicle 100 acquires a volume of stock for each region based on the stock information database 1141 (Step S503). Here, a volume of stock which includes a volume of stock of a commodity stored in the physical distribution center C and which can be loaded into the autonomously traveling vehicles 100 in the region is acquired.

The price setting unit 1045 of the control unit 104 of an autonomously traveling vehicle 100 sets a price for provision of the commodity for each region from the acquired predicted demand and the acquired volume of stock for each region and determines a maximum value and a minimum value as a scheduled price of the commodity (Step S505). Setting of the price for provision of the commodity may be performed by multiplying a standard price of the commodity by a coefficient which is calculated by performing a predetermined arithmetic operation based on the acquired predicted demand and the acquired volume of stock for each region. The maximum value and the minimum value of the commodity are determined by allocating a predetermined width to the set price for provision for each region. The predetermined width may vary depending on a predicted demand or a volume of stock. For example, when a price for provision of a commodity G1 is set to 1000 yen, the maximum value is determined to be 1100 yen and the minimum value is determined to be 900 yen. In this case, the maximum value is higher 10% than the price for provision and the minimum value is lower 10% than the price for provision, but setting of the maximum value and the minimum value is not limited thereto.

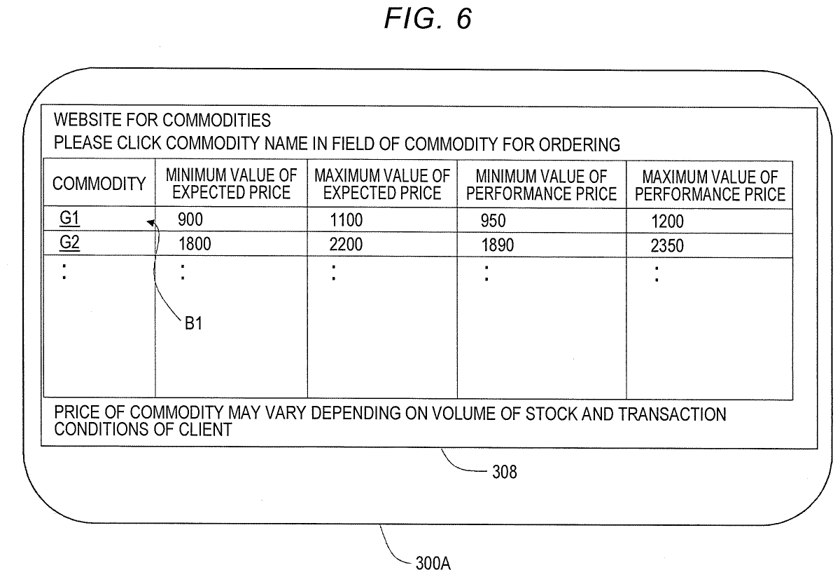

The price setting unit 1045 notifies the server 200 of the determined maximum value and the determined minimum value such that the maximum value and the minimum value are displayed on a website which is provided by the server 200. That is, the price for provision of a commodity which is determined as described above and the maximum value and the minimum value thereof are displayed on the website via the server 200. The price setting unit 1045 of the autonomously traveling vehicle 100 actively notifies user terminals 300 near the host vehicle or correlated with position information close thereto such that the information is displayed on the display unit 308. The application 3061 operates in the user terminal 300 for the purpose of display on the display unit 308. An example in which maximum values and minimum values of commodities are displayed on the display unit 308 of the user terminal 300 is illustrated in FIG. 6. Here, when the application 3061 accesses the price setting unit 1045 of the autonomously traveling vehicle 100 via the network N, the price setting unit 1045 of the user terminal 300 may display the price for provision of a commodity on the user terminal 300 which is an access source. As described above, the user terminal 300 can display a maximum value and a minimum value of a commodity by accessing a website or the application 3061. In FIG. 6, a minimum value and a maximum value of an actual sale price (a performance price) in addition to a maximum value and a minimum value of a commodity are displayed. Accordingly, a user of the user terminal 300A can predict a maximum value or a minimum value of a commodity which is ordered by the user within a predetermined range.

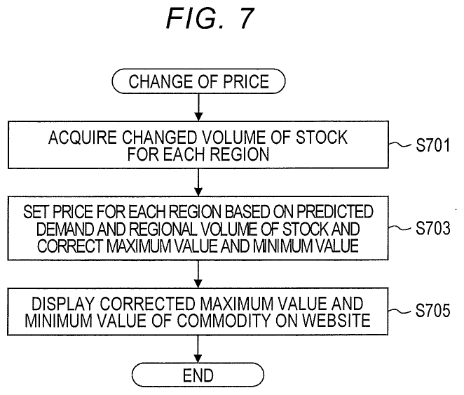

A maximum value and a minimum value of a commodity are corrected with change in a volume of stock of the commodity. This correction will be described below with reference to the flowchart illustrated in FIG. 7.

The price setting unit 1045 of the control unit 104 of an autonomously traveling vehicle 100 acquires a volume of stock of a commodity in a region (Step S701). This acquisition of a volume of stock may be performed when the volume of stock changes to be greater than a threshold value or when a predetermined time has come in, for example, periodically.

Then, the price setting unit 1045 corrects and sets the previously set price for provision for each region based on the acquired volume of stock and determines a maximum value and a minimum value as a scheduled price of the commodity (Step S703). For example, when the volume of stock decreases, the price for each region and the maximum value and the minimum value thereof can be corrected to be higher. On the other hand, when the volume of stock increases, the price for each region and the maximum value and the minimum value thereof can be corrected to be lower. Then, the corrected minimum value and the corrected maximum value are displayed on the screen of the website or the application 3061 (Step S705).

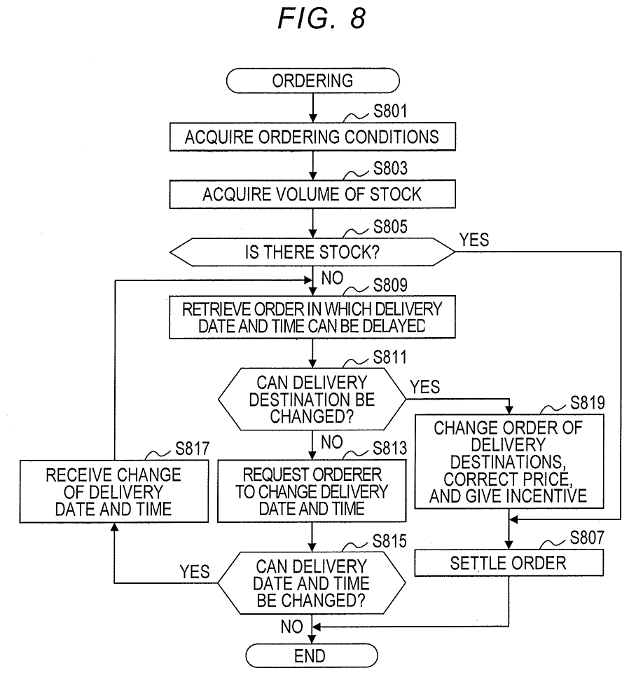

A routine when a commodity G1 is ordered from the user terminal 300A on which the maximum value and the minimum value are displayed will be described below with reference to the flowchart illustrated in FIG. 8.

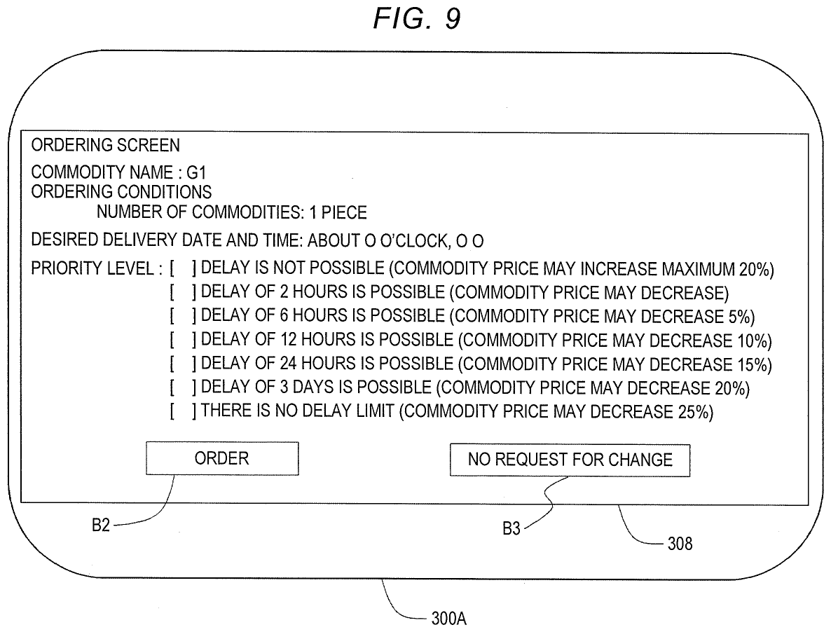

First, the sales unit 1046 of the control unit 104 of the autonomously traveling vehicle 100A acquires ordering conditions (Step S801). When a button B1 of the commodity G1 is pressed in the user terminal 300A illustrated in FIG. 6 which is communicating with the autonomously traveling vehicle 100A, an ordering screen illustrated in FIG. 9 is displayed on the display unit 308 of the user terminal 300A. On the ordering screen, the number of commodities G1 ordered, a desired delivery date and time, and a priority level of provision can be input. In FIG. 9, the number of commodities ordered is set to one. The ordering conditions are not limited to the number of commodities, the desired delivery date and time, and the priority level of provision. When a user inputs the ordering conditions, the user can press an order button B2. When the order button B2 is pressed, the ordering conditions are transmitted from the user terminal 300A to the autonomously traveling vehicle 100A. Accordingly, the sales unit 1046 of the control unit 104 of the autonomously traveling vehicle 100A can acquire the ordering conditions.

The desired delivery date and time and the priority level of provision reflect a degree of demand for the commodity by a user who is customers. For example, when the desired delivery date and time is slightly later than the current time (for example, one hour after), the degree of demand for the commodity can be said to be high. In FIG. 9, “delay is not possible,” “delay of 2 hours is possible,” “delay of 6 hours is possible,” “delay of 12 hours is possible,” “delay of 24 hours is possible,” “delay of 3 days is possible,” and “there is no delay limit” are illustrated as priority levels of provision such that one can be selected therefrom. For example, when “delay is not possible” is selected, the degree of demand for the commodity can be said to be higher than that when “there is no delay limit” is selected. When a user designates one priority level from the information of the ordering screen of FIG. 9, the user can recognize how a price of the commodity varies and perform ordering.

When the ordering conditions are acquired, the sales unit 1046 acquires a volume of stock of the commodity G1 (Step S803). Here, the volume of stock of the commodity G1 which is loaded in the autonomously traveling vehicle 100A is first acquired. The volume of stock is acquired by searching the stock information database 1141. The volume of stock mentioned herein means that the number of remaining commodities of which an order has not been settled.

Then, the number of commodities G1 ordered in the ordering conditions is compared with the volume of stock (Step S805). As a result, when the number of commodities G1 ordered in the ordering conditions is equal to or less than the volume of stock, “there is stock” is determined (YES in Step S805). As a result, an order is settled and an operation command for delivering the commodity G1 to a place of the position information correlated with the user terminal 300A, that is, a store H1 herein, is sent to the plan creating unit 1041 of the autonomously traveling vehicle 100A (Step S807). The operation command includes position information which is correlated with the user terminal 300A and acquired based on the user information database 2064. At this time, a signal indicating settlement of an order is sent to the user terminal 300A and display of the order button B2 is changed to settlement of an order. Another display indicating settlement of an order may be made.

On the other hand, when the number of commodities G1 ordered in the ordering conditions is greater than the volume of stock, “there is no stock” is determined (NO in Step S805). At this time, the sales unit 1046 of the autonomously traveling vehicle 100A retrieves an order of which a delivery time can be delayed (Step S809). For example, a commodity that can be ordered by interruption in the current ordering conditions out of the commodities G1 of which an order has been settled is retrieved from the ordering conditions of the commodity G1 in stock stored in the stock information database 1141. For example, when a desired delivery date and time in the ordering conditions from the user terminal 300A is one hour after and “delay is not possible” is selected, it is ascertained whether there is an order in which “there is no delay limit” is selected in the ordering conditions of the commodity G1 of which an order has been settled. Here, an order in which the delivery order of commodities can be changed within an allowable delay time as well as “there is no delay limit” may be specified.

Then, it is determined whether a delivery destination of the commodity G1 can be changed (Step S811). For example, when an order of the commodity G1 in which the delivery time can be delayed is not retrieved through the retrieval of Step S809, it means that the delivery destination of the commodity G1 cannot be changed and the determination result is negative (NO in Step S811). When the commodity G1 cannot be additionally supplied from the other autonomously traveling vehicles 100B or the physical distribution center C and the commodity G1 is preferentially provided to the user of the user terminal 300A, it is not clear that the commodity G1 can be provided to the customer, that is, a user, for which an order has been settled and thus it is negatively determined that the delivery destination of the commodity G1 cannot be changed (NO in Step S811). At this time, display of a change request button B3 on the ordering screen in FIG. 9 is changed to “there is a request for change” to request an orderer, that is, the user of the user terminal 300A, to change the delivery date and time (Step S813). Accordingly, change of the ordering conditions such as the delivery date and time can be input on the ordering screen. When change of the delivery date and time is possible, the user changes the ordering conditions and presses the order button B2 of the user terminal 300A again. Accordingly, the changed ordering conditions are sent to the autonomously traveling vehicle 100A (YES in Step S815). Accordingly, change of the delivery date and time is accepted (Step S817), and the sales unit 1046 of the autonomously traveling vehicle 100A retrieves an order in which the delivery time can be delayed again (Step S809).

On the other hand, for example, when there is an order in which “there is no delay limit” is selected as a priority level and the commodity G1 can be provided to the user who is an existing customer using another autonomously traveling vehicle 100B, it is determined that the delivery destination of the commodity G1 can be changed (YES in Step S811). When there is an order in which the delivery time can be delayed and which is suitable for the priority level designated in Step S801, the sales unit 1046 determines that ordering can be interrupted though “there is no delay limit” is not selected as the priority level. That is, the sales unit 1046 determines that the delivery destination of the commodity G1 can be changed. The sales unit 1046 changes the delivery destination of the commodity G1 to the user of the user terminal 300A, that is, a new customer. The sales unit 1046 increases the price of the commodity G1, for example, by 20% from the set price for provision depending on the degree of demand for the commodity G1 in the new customer (Step S819). This correction of a price is performed in accordance with the first rule and the second rule. Changing the delivery destination of the commodity G1 to a new customer and increasing the price thereof is an example of correcting the price for provision set based on the degree of demand for the commodity in the customers and changing the order of supplying the commodity. The increase of the price for provision is not limited to 20%. At this time, the sales unit 1046 may determine the increase of the price for provision in consideration of a current volume of stock of the commodity G1. The process of Step S819 is an example of correcting the price for provision based on at least one of the degree of demand for the commodity in the customers and the volume of stock of the commodity. The volume of stock of the commodity G1 is updated with selling of the commodity G1. Accordingly, display of the order button B2 is changed to settlement of the order (Step S807) and the user can ascertain a price for purchase of the commodity G1 by touching the order button B2. On the other hand, a predetermined incentive is additionally given to the user of the user terminal 300 to which delivery has been delayed due to change of the delivery destination, that is, the existing customer, at the time of provision of the commodity G1 (Step S819). This incentive is, for example, a discount coupon. The commodity G1 is provided to the user of the user terminal 300 to which delivery has been delayed due to change of the delivery destination at the price for provision of the commodity G1 which has been already settled. Here, the autonomously traveling vehicle 100A sends an operation command to the autonomously traveling vehicle 100B via the server 200 such that provision of the commodity G1 from another autonomously traveling vehicle 100B and giving of the predetermined incentive are performed on the user of the user terminal 300 to which delivery has been delayed due to change of the delivery destination.

As described above, in the first embodiment, the control unit 104 of an autonomously traveling vehicle 100 performs a process of setting a price for provision when a commodity is provided based on a volume of stock of the commodity based on the stock information database 1141 and demand prediction information of the commodity based on the demand prediction information database 2062, correcting the set price for provision based on a degree of demand for the commodity in customers, and providing the commodity to the customer at the corrected price for provision. Accordingly, it is possible to appropriately enhance a rate of commodity provision in consideration of demand of the commodity. When there is no stock of a commodity but a delivery destination can be changed, the commodity is preferentially provided to a new customer at a certain high price, the commodity is delivered to the customer of which the delivery destination has been changed from another autonomously traveling vehicle or the like, and the price for provision of the commodity is maintained at the previously set price. Accordingly, it is possible to provide a commodity at a high price depending on a degree of demand in customers. Since a predetermined incentive is given to the customer of which the delivery destination has been changed, ordering from the customers is further promoted.

A second embodiment of the disclosure will be described below. In the first embodiment, setting of a price for provision of a commodity and correcting of the price for provision based on a degree of demand for the commodity in customers are performed by an autonomously traveling vehicle which is a mobile object. On the other hand, in the second embodiment, such processes are performed by the server 200 which is an information processing device. In the following description, differences between the second embodiment and the first embodiment will be mainly described and repeated description will be omitted.

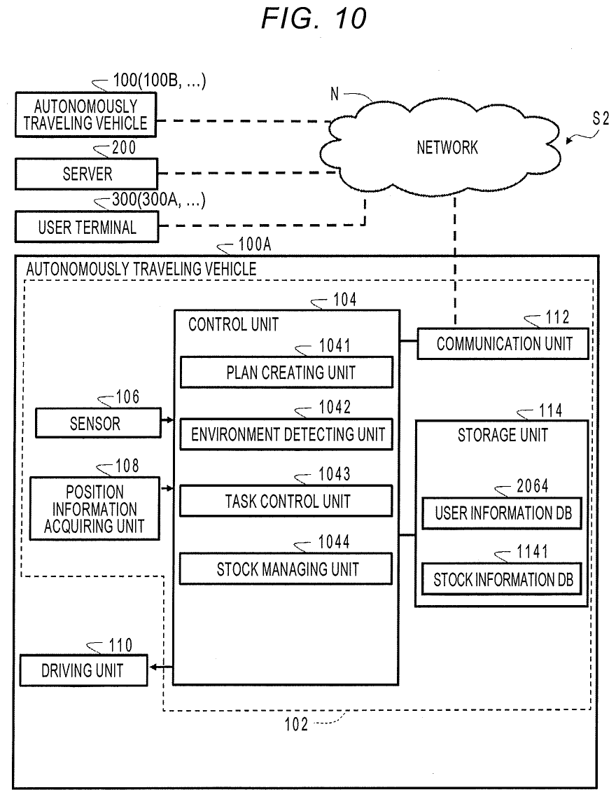

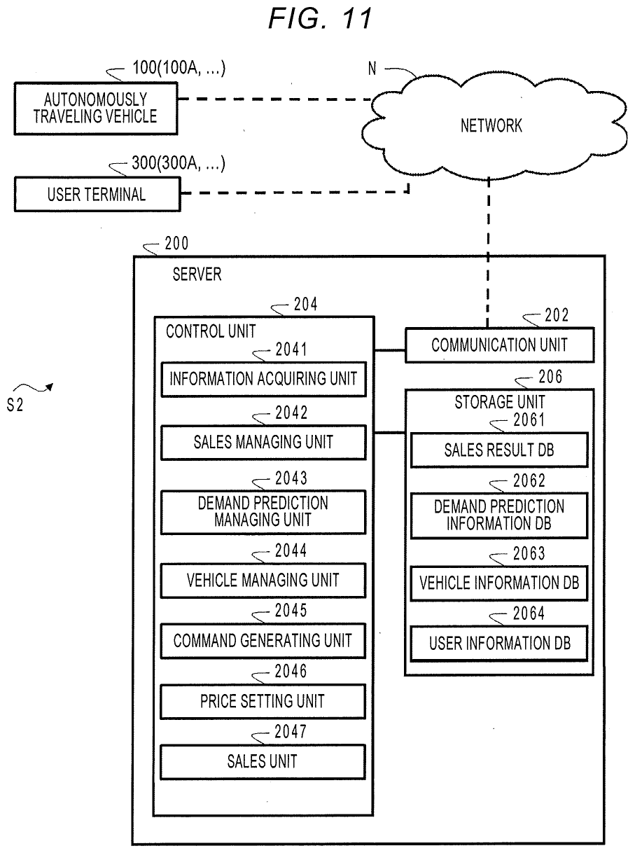

FIG. 10 is a block diagram schematically illustrating a configuration in a physical distribution management system S2 according to the second embodiment and particularly illustrating a configuration of an autonomously traveling vehicle 100. FIG. 11 is a block diagram schematically illustrating a configuration in the physical distribution management system S2 and particularly illustrating a configuration of a server 200.

As illustrated in FIG. 10, the control unit 104 of the autonomously traveling vehicle 100A includes a plan creating unit 1041, an environment detecting unit 1042, a task control unit 1043, and a stock managing unit 1044 as functional modules, but does not include the price setting unit 1045 and the sales unit 1046. On the other hand, as illustrated in FIG. 11, the control unit 204 of the server 200 includes a price setting unit 2046 and a sales unit 2047 in addition to the information acquiring unit 2041, the sales managing unit 2042, the demand prediction managing unit 2043, the vehicle managing unit 2044, and the command generating unit 2045 as functional modules. A user terminal 300 does not transmit and receive information or the like to and from an autonomously traveling vehicle 100, but transmits and receives information or the like to and from the server 200. Accordingly, the server 200 provides information such as a set price for provision of a commodity to the user terminal 300, performs receiving an order from the user terminal 300, correcting the price for provision of the commodity, and the like, and notifies the autonomously traveling vehicle 100 of information such as position information of customers such that a commodity can be provided to the user of the user terminal 300, that is, the customer.

Setting of a price for provision of a commodity in the server 200 will be described below in brief with reference to FIGS. 5 and 7. That is, in the second embodiment, the routines illustrated in FIGS. 5 and 7 are performed by the server 200, and the process details thereof are the same as the routines which are performed by the autonomously traveling vehicle 100 in the first embodiment. The price setting unit 2046 of the control unit 204 of the server 200 acquires a today predicted demand for the commodity for each region based on information in the demand prediction information database 2062 (Step S501). Then, the price setting unit 2046 acquires a volume of stock in each region based on information in the vehicle information database 2063 including information from the autonomously traveling vehicles (Step S503). Here, the vehicle information database 2063 includes information in the stock information databases 1141 of the autonomously traveling vehicles 100 acquired by the information acquiring unit 2041, particularly, the volume of stock of the commodity, and this information corresponds to first management information. The price setting unit 2046 sets a price for provision of the commodity and a maximum value and a minimum value thereof based on the predicted demand and the volume of stock (Step S505). Accordingly, the sales unit 2047 of the control unit 204 enables the determined maximum value and the determined minimum value to be displayed on a website and enables the determined values to be displayed on a display unit 308 of a user terminal 300 which accesses the website (Step S507). The price setting unit 2046 can correct the price for provision, the maximum value, and the minimum value (Step S703) by acquiring a volume of stock in a predetermined region (Step S701). Accordingly, the sales unit 2047 can display the corrected maximum value and the corrected minimum value on the website (Step S705).

Setting the price for provision of the commodity is performed for each region. A maximum value and a minimum value based on the price for provision for each region are displayed on the website. That is, by allowing a user to select a region using a user terminal 300, the screen of FIG. 6 including the price for provision of the selected region is displayed on the display unit 308 of the user terminal 300. The range of a “region” in the second embodiment can be appropriately determined based on characteristics of a commodity, a sales trend thereof, and the like.

In the system S1 according to the first embodiment, information from an autonomously traveling vehicle 100 is displayed on a website and is directly and actively transmitted to a specific user terminal 300. Accordingly, transmission and reception of information such as ordering conditions or the like is performed directly between the autonomously traveling vehicle 100 and the user terminal 300. However, in the system S2 according to the second embodiment, the server 200 displays information on a website and transmission and reception of information such as ordering conditions or the like is performed between the server 200 and the user terminal 300. When an order has been settled, an autonomously traveling vehicle 100 which is suitable for delivery of a commodity to a delivery destination is identified, for example, from position information correlated with a user ID or a terminal ID of a user terminal 300 of a user for which an order has been settled and the autonomously traveling vehicle is notified of information on customers of the user terminal in order to deliver the commodity of which an order has been settled.

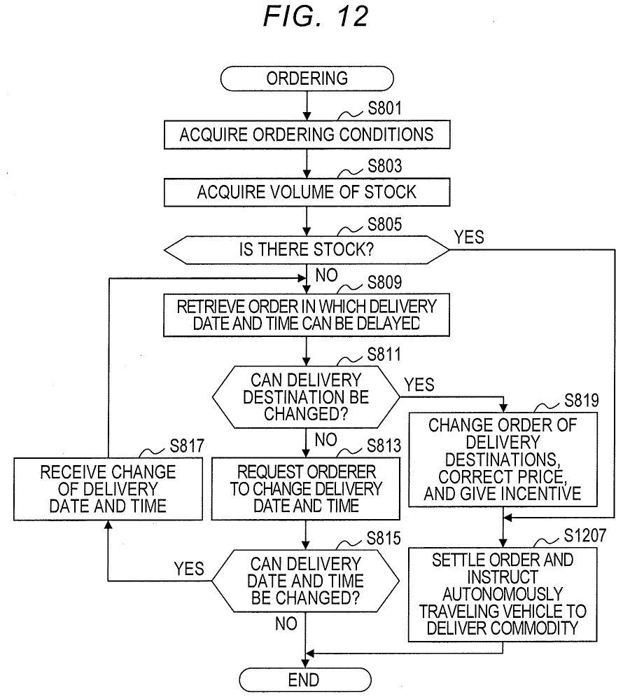

The server 200 can settle an order by performing the routine which has been described above with reference to the flowchart of FIG. 8 based on the ordering conditions from a user terminal 300. The flowchart illustrated in FIG. 12 according to the second embodiment is different from the flowchart illustrated in FIG. 8 in that Step S1207 is performed instead of Step S807. In the following description, steps other than Step S1207 in FIG. 12 will be described in brief.

The server 200 supplies a maximum value and a minimum value of a scheduled price for provision of a commodity to a website to be accessible. Accordingly, as illustrated in FIG. 6, maximum values and minimum values of commodities can be displayed on the display unit 308 of each user terminal 300. In this state, when the above-mentioned ordering conditions are input from a user terminal 300 which accesses the website, the ordering conditions are sent to the server 200. When the ordering conditions are acquired (Step S801), the sales unit 2047 of the server 200 acquires a volume of stock of a commodity in the ordering conditions (Step S803). Here, a volume of stock of the commodity in a region which is input by a user is acquired based on the vehicle information database 2063. The region may be determined from position information correlated with a user ID or a terminal ID of a user terminal 300 by the server 200. The volume of stock of a commodity in a region is, for example, a value obtained by collecting stock of autonomously traveling vehicles 100 which are located in the region or are scheduled to travel in the region. The number of commodities ordered in the ordering conditions is compared with the volume of stock (Step S805). As a result, when the number of commodities ordered in the ordering conditions is equal to or less than the volume of stock, “there is stock” is determined (YES in Step S805) and the order is settled. A process after the order has been settled will be described later. A desired delivery date and time and a priority level of provision such as information on whether delay is possible or a delay time which are included in the ordering conditions acquired in Step S801 are examples of information indicating a degree of demand for a commodity. The server 200 may update the demand prediction information database 2062 by accumulating the ordering conditions acquired in Step S801.

On the other hand, when the number of commodities ordered in the ordering conditions is greater than the volume of stock, “there is no stock” is determined (NO in Step S805). At this time, the sales unit 2047 of the server 200 retrieves an order of which a delivery time can be delayed (Step S809). Then, it is determined whether the delivery destination of the commodity can be changed (Step S811). For example, when an order of the commodity of which a delivery time can be delayed is not retrieved through retrieval of Step S809, it is determined that the delivery destination of the commodity cannot be changed (NO in Step S811). At this time, display of the change request button B3 on the ordering screen illustrated in FIG. 9 is changed to “there is a change request” such that an orderer, that is, a user of the user terminal 300, is requested to change the delivery date and time (Step S813). Accordingly, change of the ordering conditions such as the delivery date and time can be input on the ordering screen. When the delivery date and time can be changed, the user changes the ordering conditions and presses the order button B2 of the user terminal 300 again. Accordingly, the changed ordering conditions are sent to the server 200 (YES in Step S815). Accordingly, change of the delivery date and time is accepted (Step S817), and the sales unit 2047 of the server 200 retrieves an order of which the delivery time can be delayed again (Step S809).

On the other hand, for example, when there is an order in which “there is no delay limit” has been selected and the commodity can be supplied to a user who is a previously existing customer within a certain period, it is determined that the delivery destination of the commodity can be changed (YES in Step S811). Then, the sales unit 2047 changes the delivery destination of the commodity to a user of a user terminal 300, that is, a new customer. The sales unit 2047 increases the price of the commodity, for example, by 15% from the set price for provision based on a degree of demand of the commodity in the new customer (Step S819). This increase is determined every time based on a table in which a relationship between a delivery time and an extra price is defined, a table in which a relationship between a priority level of provision and an extra price is defined, a volume of stock of the commodity, and the like. This correction of a price is performed based on the first rule and the second rule. Changing the delivery destination of the commodity to a new customer and increasing the price thereof is an example of correcting the set price for provision and changing the order of supplying the commodity depending on a degree of demand of the commodity in the customers. On the other hand, when the commodity is provided to a user of a user terminal to which delivery has been delayed due to change of a delivery destination, that is, the existing customer, a predetermined incentive is additionally given to the existing customer (Step S819). The commodity is provided to the user of the user terminal 300 to which delivery has been delayed due to change of the delivery destination at the settled price for provision of the commodity. The process of Step S819 is an example of correcting the price for provision based on at least one of a degree of demand for the commodity in the customers and the volume of stock of the commodity.

When an order has been settled, the determination result of Step S805 is positive or a predetermined incentive is given in Step S819. At this time, the sales unit 2047 of the control unit 204 of the server 200 acquires position information such as an address correlated with the user terminal 300 based on the user information database 2064. Then, the sales unit 2047 supplies the position information, information on the commodity, and information on the price for provision to the command generating unit 2045. Accordingly, the command generating unit 2045 of the control unit 204 identifies an autonomously traveling vehicle 100 which is suitable for delivering the commodity to the demander based on the supplied position information and the vehicle information database 2063, generates an operation command including the information on the commodity, information on the price, and information on the customer, and notifies the autonomously traveling vehicle 100 of the generated operation command. In the notified autonomously traveling vehicle 100, a task such as delivery of the commodity to the customer is performed as described above. In this way, the commodity can be appropriately provided.

In this way, the server 200 in the physical distribution management system S2 performs the above-mentioned physical distribution management method in cooperation with an autonomously traveling vehicle 100 that delivers a commodity via the network N. In brief, the server 200 performs acquiring first management information including a volume of stock of a commodity from the autonomously traveling vehicle 100, setting a price for provision of a commodity when the commodity is provided based on the acquired first management information and second management information including demand prediction information of the commodity, correcting the set price for provision based on a degree of demand of the commodity in customers, and notifying the autonomously traveling vehicle 100 of the customer to which the commodity is provided at the corrected price for provision.

In the physical distribution management system S2 according to the second embodiment, the vehicle managing unit 2044 of the control unit 204 of the server 200 can acquire information on stock of the commodity or receipt of the commodity from a plurality of autonomously traveling vehicles 100 or commodity provision sources (for example, a physical distribution center C) via the information acquiring unit 2041. Then, the vehicle managing unit 2044 updates information in the vehicle information database 2063 including the acquired information in the stock information database 1141 using the information.

In the second embodiment, when the order of provision is changed such that delivery of a commodity to a previously existing customer is delayed and the commodity is preferentially provided to a new customer, a price for provision of the commodity is corrected. However, this is only an example. For example, when “delay of 3 days is possible” is selected as the ordering conditions and the order has been settled, the price for the commodity may be decreased by maximum 20% from the price for provision and the commodity may be provided as illustrated in FIG. 9 without changing the order of provision. Similarly, for example, when “delay is not possible” is selected as the ordering conditions or a date and time at which one hour has elapsed from the current time is designated as a desired delivery date and time and the order has been settled, the price for the commodity may be increased, for example, by maximum 20% from the price for provision and the commodity may be provided without changing the order of provision. This correction of a price can be performed based on the demand prediction information in the demand prediction information database 2062, the volume of stock of the commodity, or the like.

In the second embodiment, the price setting unit 2046 of the server 200 sets a price for provision of a commodity and a maximum value and a minimum value thereof based on a predicted demand and a volume of stock, and the sales unit 2047 performs changing a delivery destination of the commodity and correction of the set. However, similar to the first embodiment, a part of such a process may be performed by an autonomously traveling vehicle 100A. For example, the price setting unit 2046 of the server 200 may set a price for provision of a commodity and a maximum value and a minimum value thereof based on a predicted demand and a volume of stock similarly to the second embodiment, and the sales unit 1046 of an autonomously traveling vehicle 100A may perform changing a delivery destination of the commodity and correction of the set price similarly to the first embodiment. Since the server 200 and the autonomously traveling vehicle 100A cooperate with each other via the network N, it is apparent that the processes in the first embodiment and the processes in the second embodiment can be appropriately combined to appropriately distribute the functions to the server 200 and the autonomously traveling vehicle 100A.

A third embodiment will be described below. A physical distribution management system S3 according to the third embodiment does not include the server 200 and an autonomously traveling vehicle 100 takes charge of the functions of the server 200. That is, the physical distribution management system S3 is a system in which a plurality of autonomously traveling vehicles 100 that delivers a commodity cooperates with each other. However, the physical distribution management system S3 does not conclusively exclude a server. In the system S3 according to the third embodiment, similarly to the system S1 according to the first embodiment, information from an autonomously traveling vehicle 100 is displayed on a website and is directly and actively notified to a specific user terminal 300. Accordingly, transmission and reception of information such as ordering conditions is performed directly between an autonomously traveling vehicle 100 and a user terminal 300.

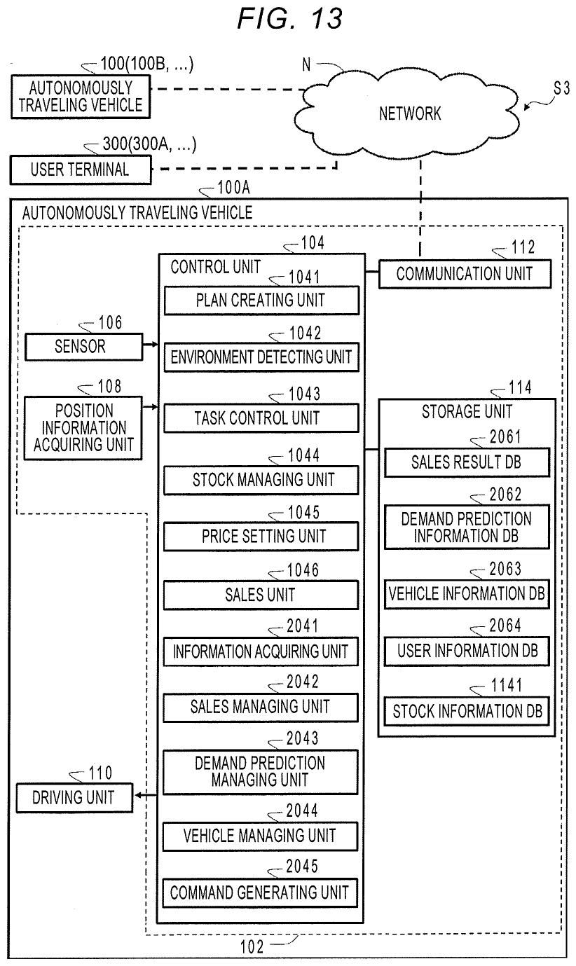

The physical distribution management system S3 is configured as a system in which a plurality of autonomously traveling vehicles 100 that delivers a commodity cooperates with each other. In the physical distribution management system S3, an autonomously traveling vehicle 100 can have, for example, the configuration illustrated in FIG. 13. The control unit 104 of the autonomously traveling vehicle 100A illustrated in FIG. 13 includes an information acquiring unit 2041, a sales managing unit 2042, a demand prediction managing unit 2043, a vehicle managing unit 2044, and a command generating unit 2045 in addition to the plan creating unit 1041, the environment detecting unit 1042, the task control unit 1043, the stock managing unit 1044, the price setting unit 1045, and the sales unit 1046 as functional modules. A sales result database 2061, a demand prediction information database 2062, a vehicle information database 2063, a user information database 2064, and a stock information database 1141 are stored in the storage unit 114 of the autonomously traveling vehicle 100A. The stock information database 1141 may be incorporated into the vehicle information database 2063. In FIG. 13, elements corresponding to the above-mentioned elements are referred to by the same reference signs in order to easily understand relations with the above-mentioned elements. The stock information database 1141 is an example of a first storage unit. The demand prediction information database 2062 is an example of a second storage unit.

The control unit 104 of an autonomously traveling vehicle 100, that is, a mobile-object control unit, can acquire information on a degree of demand for a commodity from other autonomously traveling vehicles or the like and update the demand prediction information database 2062 corresponding to second management information. The control unit 104 acquires information on stock of the commodity or receipt of the commodity from other autonomously traveling vehicles or provision sources of the commodity and updates the stock information database 1141 or the vehicle information database 2063 corresponding to the first management information. The storage unit 114 in which the first management information is stored is the same as the storage unit 114 in which the second management information is stored, but they may be separated from each other. The processes of setting and correcting a price for provision of the commodity and ordering a commodity in each autonomously traveling vehicle 100 in the physical distribution management system S3 are substantially the same as the processes in another physical distribution management system, for example, the physical distribution management system S1, and thus description thereof will not be repeated herein.

The above-mentioned embodiments are only examples and the disclosure can be appropriately modified without departing from the gist thereof. The processes or units which have been described above in the present disclosure can be freely combined as long as no technical contradictions arise.

A process which has been described to be performed by a single device may be distributed to and performed by a plurality of devices. For example, the server 200 which is an information processing device does not need to be a single computer and may be configured as a system including a plurality of computers. Alternatively, processes which have been described to be performed by different devices may be performed by a single device. In a computer system, by what hardware configuration (server configuration) each function is to be embodied can be flexibly changed.

The disclosure can also be embodied by supplying a computer program storing the functions described above in the above-mentioned embodiment to a computer and causing one or more processors of the computer to read and execute the computer program. Such a computer program may be provided to the computer via a non-transitory computer-readable storage medium which can access a system bus of the computer or may be provided to the computer via a network. Examples of the non-transitory computer-readable storage medium include an arbitrary type of disk such as a magnetic disk (such as a Floppy (registered trademark) disk or a hard disk drive (HDD)) or an optical disc (such as a CD-ROM, a DVD disc, or a blue-ray disc), a read only memory (ROM), a random access memory (RAM), an EPROM, an EEPROM, a magnetic card, a flash memory, an optical card, and an arbitrary type of medium which is suitable for storing electronic commands.

What is claimed is:

1. A physical distribution management system comprising:
a mobile object that delivers a commodity; and
an information processing device that cooperates with the mobile object via a network,
wherein the mobile object includes
a mobile-object storage unit configured to store first management information including a volume of stock of the commodity, and
a mobile-object control unit,
wherein the information processing device includes a management storage unit configured to store second management information including demand prediction information of the commodity, and
wherein the mobile-object control unit is configured to perform:
setting a price for provision when the commodity is provided based on the first management information and the second management information acquired from the information processing device; and
correcting the price for provision based on at least one of a degree of demand for the commodity in customers and the volume of stock of the commodity.

2. The physical distribution management system according to claim 1, wherein the correcting of the price for provision includes setting the price for provision to be higher for a customer for which a delivery time of the commodity is shorter.

3. The physical distribution management system according to claim 1, wherein the correcting of the price for provision includes setting the price for provision to be higher for a customer for which a priority level of provision is higher.

4. The physical distribution management system according to claim 1, wherein, when the commodity is preferentially provided to a new customer instead of an existing customer, the mobile-object control unit is configured to further perform:
correcting the price for provision of the commodity to be higher than the price for provision when the commodity is provided to the existing customer; and
giving a predetermined incentive to the commodity which is provided to the existing customer.

5. The physical distribution management system according to claim 1, wherein a management control unit of the information processing device is configured to acquire information indicating a degree of demand for the commodity and to update the second management information.

6. The physical distribution management system according to claim 1, wherein the mobile-object control unit is configured to acquire information on stock of the commodity or receipt of the commodity from the information processing device or another mobile object and to update the first management information.

7. A physical distribution management system comprising:
a mobile object that delivers a commodity; and
an information processing device that cooperates with the mobile object via a network,
wherein the mobile object includes a mobile-object storage unit configured to store first management information including a volume of stock of the commodity,
wherein the information processing device includes
a management storage unit configured to store second management information including demand prediction information of the commodity, and
a management control unit, and
wherein the management control unit is configured to perform:
setting a price for provision when the commodity is provided based on the first management information acquired from the mobile object and the second management information;
correcting the price for provision based on at least one of a degree of demand for the commodity in customers and the volume of stock of the commodity; and
notifying the mobile object of the customer to which the commodity is provided at the corrected price for provision.

8. An information processing device that cooperates with a mobile object that delivers a commodity via a network, the information processing device comprising a management control unit configured to perform:
setting a price for provision when the commodity is provided based on first management information including a volume of stock of the commodity acquired from the mobile object and second management information including demand prediction information of the commodity;
correcting the price for provision based on at least one of a degree of demand for the commodity in customers and the volume of stock of the commodity; and
notifying the mobile object of the customer to which the commodity is provided at the corrected price for provision.

9. The information processing device according to claim 8, wherein the correcting of the price for provision includes setting the price for provision to be higher for a customer for which a delivery time of the commodity is shorter.

10. The information processing device according to claim 8, wherein the correcting of the price for provision includes setting the price for provision to be higher for a customer for which a priority level of provision is higher.

11. The information processing device according to claim 8, wherein, when the commodity is preferentially provided to a new customer instead of an existing customer, the management control unit is configured to further perform:
correcting the price for provision of the commodity to be higher than the price for provision when the commodity is provided to the existing customer; and
giving a predetermined incentive to the commodity which is provided to the existing customer.

12. The information processing device according to claim 8, wherein the management control unit is configured to acquire information indicating a degree of demand for the commodity and to update the second management information.

13. The information processing device according to claim 8, wherein the management control unit is configured to acquire information on stock of the commodity or receipt of the commodity from a plurality of mobile objects including the mobile object or a provision source of the commodity and to update the first management information.

14. A mobile object in a system in which a plurality of mobile objects that delivers a commodity cooperates with each other, the mobile object comprising:
a first storage unit configured to store first management information including a volume of stock of the commodity;
a second storage unit configured to store second management information including demand prediction information of the commodity; and
a mobile-object control unit,
wherein the mobile-object control unit is configured to perform:
setting a price for provision when the commodity is provided based on the first management information and the second management information; and
correcting the price for provision based on at least one of a degree of demand for the commodity in customers and the volume of stock of the commodity.

15. A mobile object in a system in which an information processing device and a plurality of mobile objects cooperate with each other via a network, the mobile object comprising a mobile-object control unit configured to perform:
acquiring a price for provision from the information processing device when a commodity is provided;
correcting the price for provision based on at least one of a degree of demand for the commodity in customers and a volume of stock of the commodity.

16. A physical distribution management method which is cooperatively performed by a mobile object that delivers a commodity and an information processing device that cooperates with the mobile object via a network, the physical distribution management method comprising:
setting a price for provision when the commodity is provided based on first management information including a volume of stock of the commodity acquired from the mobile object and second management information including demand prediction information of the commodity; and
adjusting the set price for provision and an order of providing the commodity based on at least one of a degree of demand for the commodity in customers and the volume of stock of the commodity.
